(19) United States
(12) Patent Application Publication
(10) Pub. No.: US 2022/0305623 A1
(43) Pub. Date: Sep. 29, 2022

(54) FAN CLUTCH WRENCH

(71) Applicant: CHIUANYOU METAL CO., LTD., Taichung City (TW)

(72) Inventor: CHIN-CHUNG CHANG, Taichung City (TW)

(21) Appl. No.: 17/215,695

(22) Filed: Mar. 29, 2021

(51) Int. Cl. B25B 13/48; B25G 1/06

(52) U.S. Cl. CPC B25B 13/481; B25G 1/063

(57) ABSTRACT

A fan clutch wrench is provided, including a rod and a driving member. The driving member includes a longitudinal direction and a thickness direction, two opposite ends of the driving member on the longitudinal direction are respectively defined as a first end and a second end, the second end is rotatably connected to the rod, an engagement hole penetrates through the first end in the thickness direction, the engagement hole penetrates through the first end to form a first lateral opening along a direction which is lateral to the thickness direction and lateral to the longitudinal direction, and the first lateral opening is for a fastener of a fan clutch to pass therethrough to be engaged with the engagement hole.

### BACKGROUND OF THE INVENTION

### Field of the Invention

The present invention relates to a wrench, and more particularly to a fan clutch wrench.

### Description of the Prior Art

A fan is one of the most important components in an automotive engine cooling system. The fan helps to maintain the engine to operate within a normal temperature range without overheating, and a fan clutch is used to connect the fan and the engine axle and change a rotation speed of the fan based on temperature variation to dissipate heat efficiently. For example, when the temperature of the engine is low, the fan rotates slowly; and when the temperature of the engine is high, the fan rotates fast. This type of fan clutch is fastened to a pivoting axle through a nut.

In an automotive engine room, aside from the engine, there are also many systems, wires, pipes, heat sinks, and other components, so there is limited space around the fan. Therefore, when the fan clutch is broken and needs to be replaced, it is hard for a maintenance staff to engage the nut firmly or loosen the nut.

The present invention has arisen to mitigate and/or obviate the afore-described disadvantages.

### SUMMARY OF THE INVENTION

The major object of the present invention is to provide a fan clutch wrench. In an engine room which is full of components, a wrench can be inserted from above the engine room which is more spacious downward to be engaged with a fastener of a fan clutch, and the assembling process would be smoother and faster.

To achieve the above and other objects, a fan clutch wrench is provided, including a rod and a driving member. The driving member includes a longitudinal direction and a thickness direction, two opposite ends of the driving member on the longitudinal direction are respectively defined as a first end and a second end, the second end is rotatably connected to the rod, an engagement hole penetrates through the first end in the thickness direction, the engagement hole penetrates through the first end to form a first lateral opening along a direction which is lateral to the thickness direction and lateral to the longitudinal direction, and the first lateral opening is for a fastener of a fan clutch to pass therethrough to be engaged with the engagement hole.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown view of an embodiment of the present invention;

FIG. 2 is a stereogram of the embodiment of the present invention;

FIG. 3 is a partially-enlarged perspective view of FIG. 2;

FIG. 4 is a drawing showing the embodiment of the present invention in use;

FIG. 5 is a partially-enlarged perspective view of FIG. 4;

FIG. 6 is a drawing showing a driving member of the present invention viewed along a thickness direction; and

FIGS. 7 and 8 are drawings showing a wrench of the embodiment engaged with a fastener of a fan clutch.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

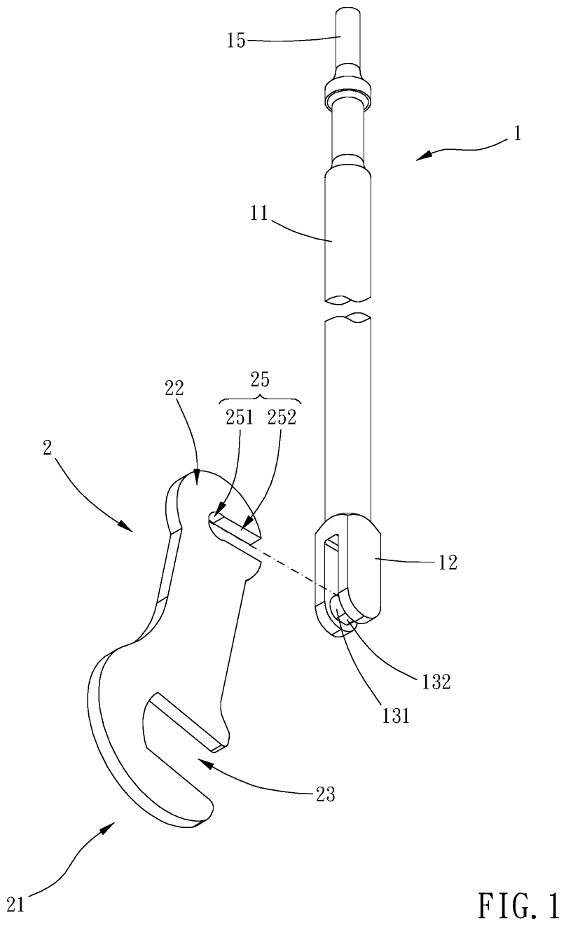

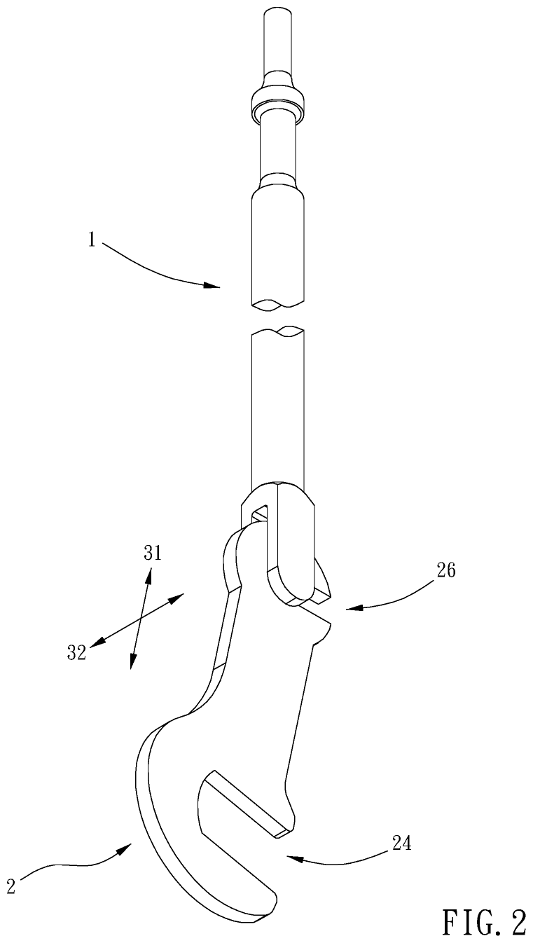

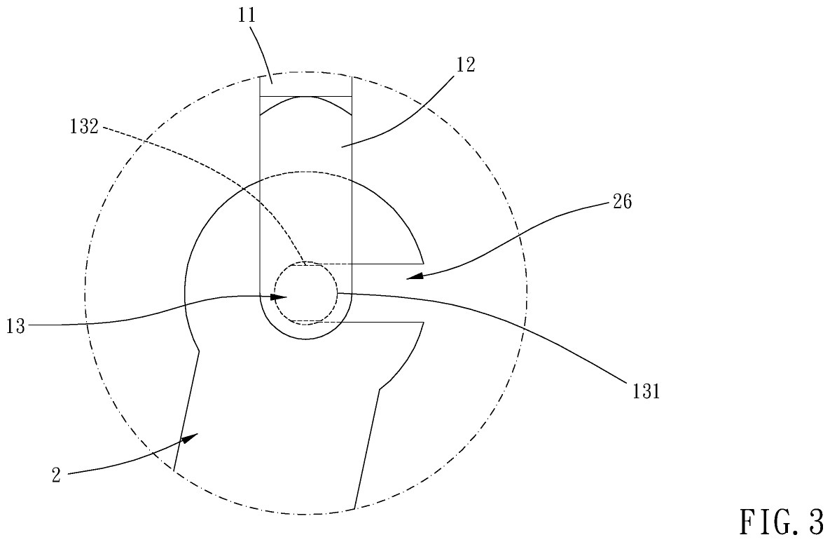

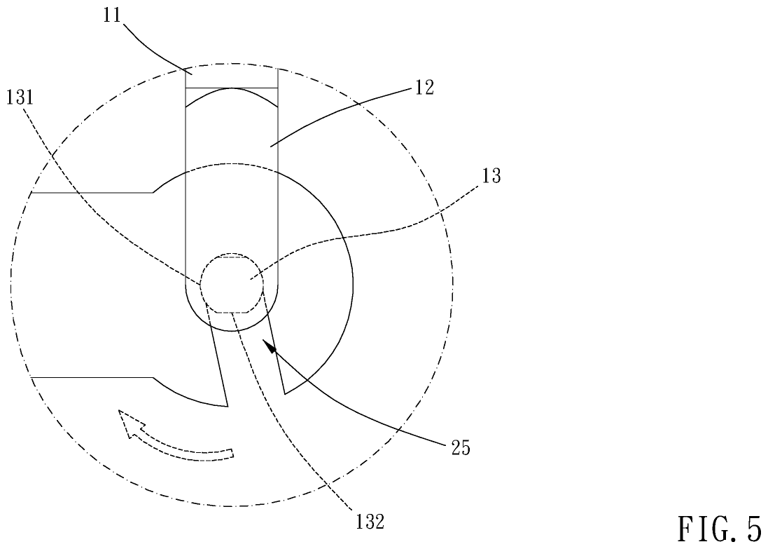

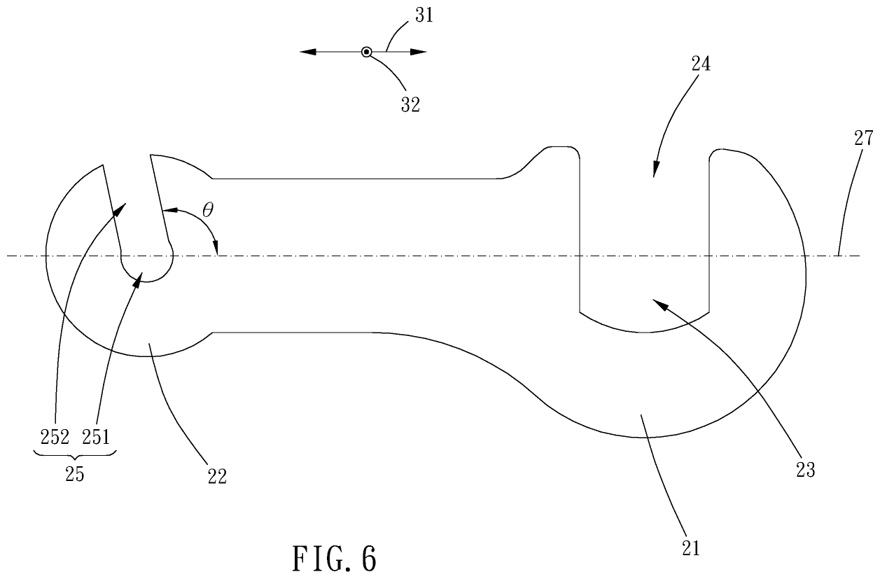

Please refer to FIGS. 1 to 8 for an embodiment of a fan clutch wrench, which includes a rod 1 and a driving member 2.

The driving member 2 is plate-shaped for being inserted into narrow spaces. The driving member 2 includes a longitudinal direction 31 and a thickness direction 32, two opposite ends of the driving member 2 on the longitudinal direction 31 are respectively defined as a first end 21 and a second end 22, on a direction perpendicular to the thickness direction 32 and the longitudinal direction 31, the first end 21 is greater than the second end 22 in dimension, the second end 22 is rotatably connected to the rod 1, an engagement hole 23 penetrates through the first end 21 in the thickness direction 32, the engagement hole 23 penetrates through the first end 21 to form a first lateral opening 24 along a direction which is lateral to the thickness direction 32 and lateral to the longitudinal direction 31, the first lateral opening 24 is for a fastener 41 of a fan clutch 4 to pass therethrough to be engaged with the engagement hole 23; wherein the term “lateral to” refers to both “perpendicular to” and “oblique to”.

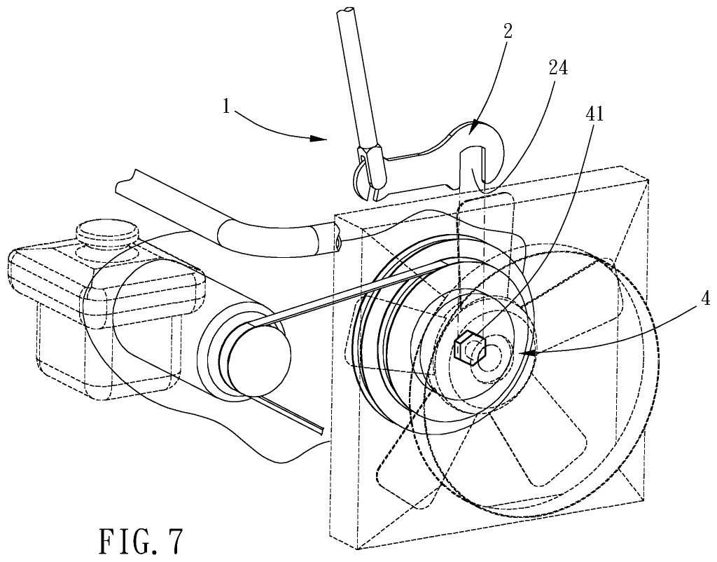

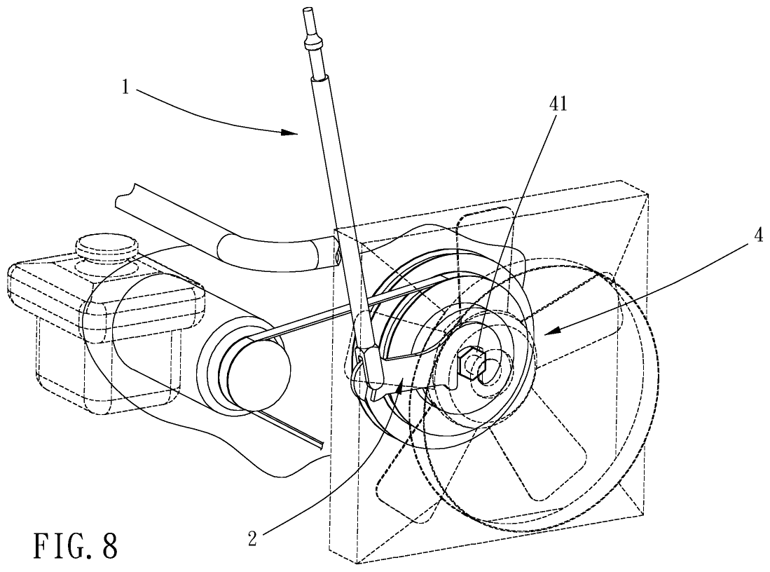

It is to be noted that because of components and pipes within an engine room and a shape of a car shell, a space around the fan clutch 4 is narrow. The first lateral opening 24 is designed to allow the driving member 2 to be inserted from above the fan clutch 4 which is more spacious downward, so a user can see a position of the fastener 41, and in actual practice, the driving member 2 and the rod can be engaged with each other in a L-shaped configuration above the fan clutch 4, as shown in FIGS. 7 and 8, once the driving member 2 is engaged with the fastener 41, the rod 1 which is positioned can drive the fastener 41 to rotate immediately, so the assembling process can be more time-efficient and smooth. The user does not need to follow traditional steps to disassemble objects on two opposite sides of the fan clutch 4 first and then to assemble, s/he does not have to grip on the driving member 2 and stretch his/her hand deep into the engine room, through many components, to engaged the driving member 2 with the fastener 41, and s/he does not have to spend extra time adjusting relative positions of the rod 1 and the driving member 2.

In this embodiment, the rod 1 includes a pivoting axle 13, a pivoting hole 25 penetrates through the second end 22 along the thickness direction 32, the pivoting hole 25 penetrates through the second end 22 to form a second lateral opening 26 along the direction which is lateral to the thickness direction 32 and lateral to the longitudinal direction 31, the second end 22 is detachably hooked on the pivoting axle 13 via the second lateral opening 26, and the driving member 2 is rotatable about the pivoting axle 13; the first lateral opening 24 and the second lateral opening 26 are on the same side of the driving member 2.

Specifically, the pivoting hole 25 further includes a first hole portion 251 and a second hole portion 252, one of two ends of the second hole portion 252 is in communication with the first hole portion 251, the other of the two ends of the second hole portion 252 is in communication with the second lateral opening 26, the second hole portion 252 extends away from the first end 21 with the first hole portion 251 as a basis, the second hole portion 252 extends obliquely, and when the rod 1 is used relatively perpendicular to the longitudinal direction 31, the pivoting axle 13 is less likely to be detached from the pivoting hole 25 through the second hole portion 252.

More specifically, the first hole portion 251 is a round through hole, the second hole portion 252 is a linear through hole with a fixed width, a diameter of the rough through hole is greater than the fixed width of the linear through hole, a virtual axis 27 extends along the longitudinal direction 31 and passes through the center of circle of the round through hole, a direction of a wall of the linear through hole facing the first end 21 and the virtual axis 27 have an included angle θ therebetween, and the included angle θ is greater than 90 degree. A profile of the pivoting axle 13 includes two arc sections 131 which have the same center of circle and same radius and have two tangent planes 132 which are arranged in parallel, the two arc sections 131 are symmetrically arranged relative to the same center of circle, the two tangent planes 132 are respectively connected between the two arc sections 131, a distance between the two tangent planes 132 is equal to or smaller than the fixed width of the linear through hole to allow the pivoting axle 13 to slide through the linear through hole conveniently, and a radius of the two arc section 131 is greater than the fixed width of the linear through hole to make sure when the driving member 2 rotates relative to the pivoting axle 13, the pivoting axle 13 is restricted within the round through hole.

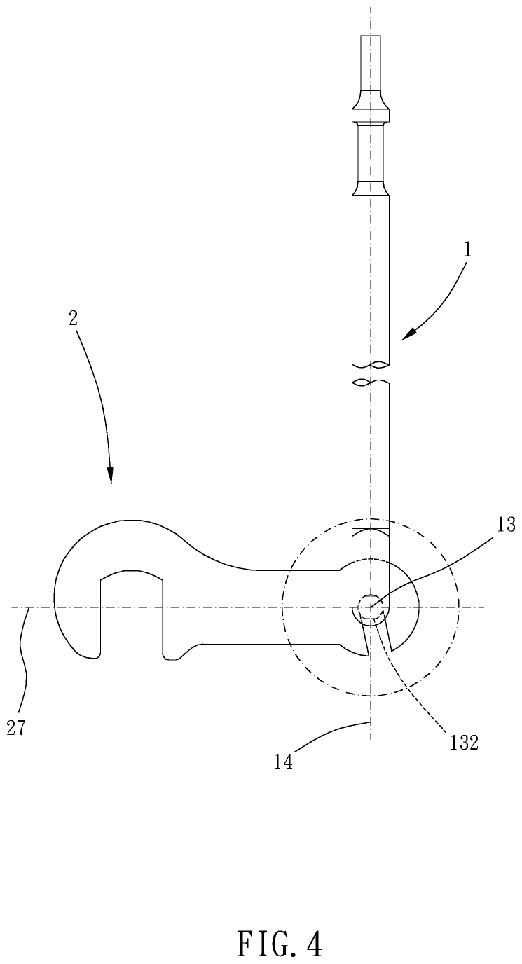

In this embodiment, as shown in FIG. 4, an axis 14 of the rod 1 passes through the two tangent planes 132, and when in use, an extension direction of the linear through hole is oblique to the two tangent planes 132, and the pivoting axle 13 is firmly restricted within the round through hole and unable to be detached from the driving member 2 so as to ensure the overall operation stability.

The rod 1 further includes a main body 11 and two wing portions 12, the two wing portions 12 are spacingly arranged and extend in parallel from the main body 1, the pivoting axle 13 is disposed through and connected between the two wing portions 12, and the main body 11, the two wing portions 12 and the pivoting axle 13 are integrally formed of one piece. For example but not limited thereto, the rod 1 is made of metal by cold forging to have a preferable structure strength.

Preferably, an end of the rod 1 remote from the driving member 2 has an impact head 15, and the impact head 15 is for being engaged with an impact tool to quickly and easily actuate the fastener 41 to rotate.

While we have shown and described various embodiments in accordance with the present invention, it should be clear to those skilled in the art that further embodiments may be made without departing from the scope of the present invention.

What is claimed is:

1. A fan clutch wrench, including:
a rod; and
a driving member, including a longitudinal direction and a thickness direction, two opposite ends of the driving member on the longitudinal direction respectively being defined as a first end and a second end, the second end being rotatably connected to the rod, an engagement hole penetrating through the first end in the thickness direction, the engagement hole penetrating through the first end to form a first lateral opening along a direction which is lateral to the thickness direction and lateral to the longitudinal direction, the first lateral opening being for a fastener of a fan clutch to pass therethrough to be engaged with the engagement hole.

2. The fan clutch wrench of claim 1, wherein the rod includes a pivoting axle, a pivoting hole penetrates through the second end along the thickness direction, the pivoting hole penetrates through the second end to form a second lateral opening along the direction which is lateral to the thickness direction and lateral to the longitudinal direction, the second end is detachably hooked on the pivoting axle via the second lateral opening, and the driving member is rotatable about the pivoting axle.

3. The fan clutch wrench of claim 2, wherein the first lateral opening and the second lateral opening are on the same side of the driving member.

4. The fan clutch wrench of claim 2, wherein the rod further includes a main body and two wing portions, the two wing portions are spacingly arranged and extend in parallel from the main body, the pivoting axle is disposed through and connected between the two wing portions, and the main body, the two wing portions and the pivoting axle are integrally formed of one piece.

5. The fan clutch wrench of claim 2, wherein the pivoting hole further includes a first hole portion and a second hole portion, one of two ends of the second hole portion is in communication with the first hole portion, the other of the two ends of the second hole portion is in communication with the second lateral opening, and the second hole portion extends away from the first end with the first hole portion as a basis.

6. The fan clutch wrench of claim 5, wherein the first hole portion is a round through hole, the second hole portion is a linear through hole with a fixed width, and a diameter of the rough through hole is greater than the fixed width of the linear through hole.

7. The fan clutch wrench of claim 6, wherein a profile of the pivoting axle includes two arc sections which have the same center of circle and same radius and have two tangent planes which are arranged in parallel, the two arc sections are symmetrically arranged relative to the same center of circle, the two tangent planes are respectively connected between the two arc sections, a distance between the two tangent planes is equal to or smaller than the fixed width of the linear through hole, and a radius of the two arc section is greater than the fixed width of the linear through hole.

8. The fan clutch wrench of claim 7, wherein an axis of the rod passes through the two tangent planes.

9. The fan clutch wrench of claim 1, wherein the rod is made of metal by cold forging.

10. The fan clutch wrench of claim 8, wherein the first lateral opening and the second lateral opening are on the same side of the driving member; the rod further includes a main body and two wing portions, the two wing portions are spacingly arranged and extend in parallel from the main body, the pivoting axle is disposed through and connected between the two wing portions, and the main body, the two wing portions and the pivoting axle are integrally formed of one piece; the rod is made of metal by cold forging; an end of the rod remote from the driving member has an impact head; the driving member is plate-shaped; on a direction perpendicular to the thickness direction and the longitudinal direction, the first end is greater than the second end in dimension; a virtual axis extends along the longitudinal direction and passes through the center of circle of the round through hole, a direction of a wall of the linear through hole facing the first end and the virtual axis have an included angle therebetween, and the included angle is greater than 90 degree.
